(19) United States
(12) Patent Application Publication
(10) Pub. No.: US 2021/0008953 A1
(43) Pub. Date: Jan. 14, 2021

(54) LEVER FOR A MOTOR VEHICLE SHUT-OFF DEVICE

(71) Applicant: Valeo Systemes Thermiques, Le Mesnil-Saint-Denis (FR)

(72) Inventors: Sylvain Gerber, Le Mesnil Saint-Denis (FR); Enzo Mitidieri, Le Mesnil Saint-Denis (FR)

(73) Assignee: Valeo Systemes Thermiques, Le Mesnil-Saint-Denis (FR)

(21) Appl. No.: 16/978,095

(22) PCT Filed: Feb. 28, 2019
(86) PCT No.: PCT/FR2019/050458

§ 371 Date: Sep. 3, 2020

(30) Foreign Application Priority Data
Mar. 5, 2018 (FR) 1800191

(51) Int. Cl. B60H 1/00; B60H 1/34

(52) U.S. Cl. CPC B60H 1/0065; B60H 2001/3471; B60H 1/3421

(57) ABSTRACT

The present invention relates to a lever (11) having: an engagement part (16) designed to engage in a corresponding housing in a component with which the lever is intended to cooperate, a base (18) to which the engagement part is connected, a connecting zone (20) between the engagement part and the base, this connecting zone having a profile extending from the engagement part to the base, said profile having a gradual curve shape, this connecting zone also comprising at least one stop (21) adjacent to the profile with a gradual curve shape.

A subject of the invention is thus a lever, in particular for a motor vehicle AGS.

The front faces of motor vehicles are generally made up of two main air inlets, referred to as the top route and the bottom route, separated by a bumper beam. The heat exchangers of the motor vehicle, such as for example that used for air-conditioning the passenger compartment and/or that used for cooling the engine, are generally placed behind this bumper beam.

It is also known to dispose, in the path of air passing through the main air inlets, more generally the bottom route, a support frame having a multiplicity of flaps mounted so as to pivot about parallel axes and able to adopt a multiplicity of different angular positions, between an open position and a closure position, under the action of appropriate control means.

A closure device resembling a Venetian blind is thus obtained that allows the flow rate of air passing through the air inlets and arriving at the heat exchangers to be adjusted. It is thus possible to optimize the effectiveness of these heat exchangers depending on the requirements by varying the amount of air that they receive. In addition, at high speed, the flaps in the closure position allow the drag coefficient of the vehicle to be reduced, and thus improve the aerodynamics of said vehicle.

The flaps of such closure devices are generally molded.

The devices below are also referred to as AGSs (Air Grille Shutters).

In these AGSs, it is known to use a motor and, connected thereto, a lever that itself causes the one or more objects, for example flaps of the AGS, to move. This type of closure device, or AGS, usually has an actuator, a lever, a linkage, flaps, a frame and a cover.

When maneuvered, the lever experiences a torsional load since it is trapped between the actuator and the weight, or even the pressure of the air that is applied to the objects to be turned, for example flaps.

The fact of experiencing these loads creates local stress regions, in particular around the base of the anchoring of the part engaged in the actuator.

According to the observation of the applicant, this phenomenon is due to too sharp a shape between the engagement part of the lever and the base of the lever.

Starting from this observation, which is not obvious, the applicant has proposed the below invention.

A subject of the invention is thus a lever having:
an engagement part arranged so as to engage in a corresponding recess of a component with which the lever is intended to cooperate,
a base to which the engagement part is connected,
a connection region between the engagement part and the base, this connection region having a profile extending from the engagement part toward the base, which profile has a progressive curve shape, this connection region also comprising at least one stop that is adjacent to the profile with progressive curve shape.

By virtue of the invention, by increasing the value of the radius of the connection region between the base and the engagement part, it is possible to maintain the integrity of the lever, in particular by preventing premature fatigue of the lever regardless of the material, and the invention allows the performance of the lever in terms of endurance to be improved. The stops serve to guarantee contact with the actuator for example, in particular for the assembly that requires a certain clearance between components.

The invention is not applicable only to AGSs, and is applicable to all similar systems made from any material.

According to one aspect of the invention, the connection region has a plurality of stops, which are in particular evenly angularly distributed around the axis of rotation.

According to one aspect of the invention, the profile with progressive curve shape is present between two neighboring stops.

According to one aspect of the invention, the stop has at its end a flat arranged so as to come to bear on a collar of the associated component.

According to one aspect of the invention, the engagement part has ribs that are parallel to the axis of rotation, and the stops are each arranged in the extension of one of these ribs.

According to one aspect of the invention, the profile with progressive curve shape is an arc of a circle.

According to one aspect of the invention, the profile with progressive curve shape extends along the entire length of the stop.

According to one aspect of the invention, the profile with progressive curve shape is more extensive than the collar of the component with which the lever is intended to cooperate.

According to one aspect of the invention, the engagement part is connected to a sector of the base that is substantially circular. This sector of the base preferably has an extent greater than the base of the engagement part. In particular this sector has a diameter greater than the diameter of the base of the engagement part.

According to one example of the invention, the connection region connects the base of the engagement part to this sector. Thus the profile with progressive curve shape extends from the base of the engagement part to this sector.

Preferably, the profile with progressive curve shape has a concavity directed radially outward.

According to one aspect of the invention, the connection region has a substantially conical shape, which is flared toward the base.

In general, the connection region advantageously has a shape that is flared toward the base.

According to one aspect of the invention, the base is moved away by a non-zero distance from the collar of the component with which the lever is intended to cooperate.

According to one aspect of the invention, the lever is made in a single piece, in particular from plastic material.

According to one aspect of the invention, the lever is arranged so as to be disposed between a rod and an actuator of a closure device for a motor vehicle front face air inlet.

As a variant, the lever could be a lever of a flap of the air intake device.

In general, the lever is arranged so as to be fitted to any mechanism that is arranged so as to operate by mechanical loading of the lever.

Another subject of the invention is a closure device for a motor vehicle front face air inlet, comprising a support frame in which is installed at least one set of flaps pivoting between a closure position and an open position,

characterized in that the closure device has:
a rod that is able to move in translation and is connected to the flaps so as to cause said flaps to pass from one position to another,
an actuator arranged so as to actuate the rod,
a lever as claimed in one of the preceding claims, disposed between the actuator and the rod.

Further features and advantages of the invention will become more clearly apparent upon reading the following description, which is given by way of illustrative and non-limiting example, and the appended drawings, in which:

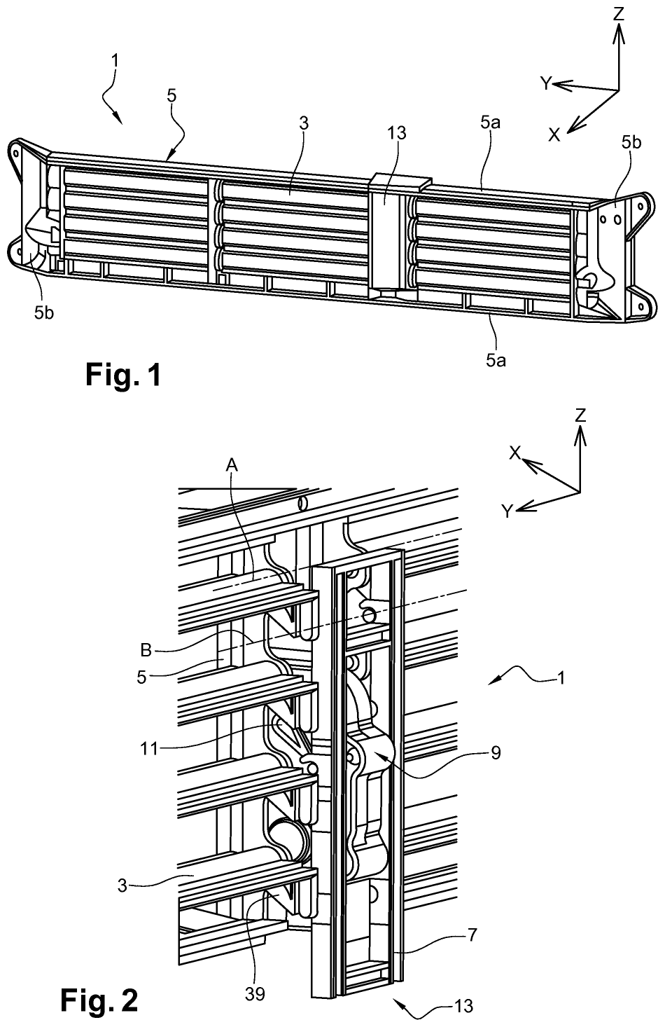

FIG. 1 shows a schematic front-perspective depiction of a closure device in the closure position,

FIG. 2 shows a schematic perspective depiction of a control element,

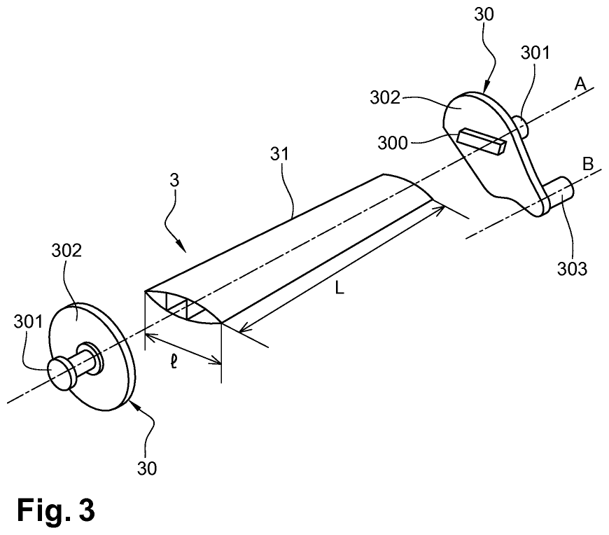

FIG. 3 shows a schematic exploded-perspective depiction of a flap,

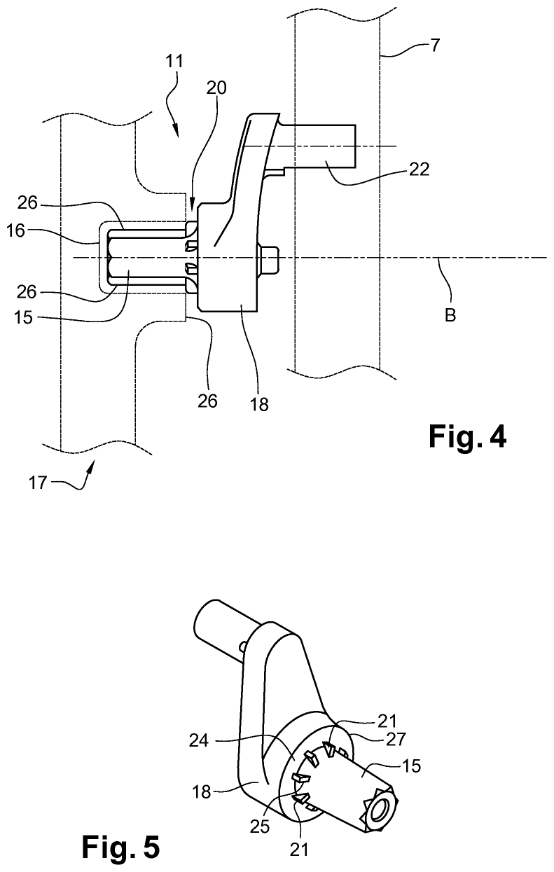

FIGS. 4 and 5 illustrate a lever according to one exemplary embodiment of the invention.

In FIGS. 1 and 2, an XYZ trihedron is used in order to show the viewing angle of each of said figures relative to one another. The axes of this trihedron may also correspond to the various orientations of the motor vehicle. The X axis may thus correspond to the axis of the length of the vehicle, the Y axis to the axis of its width and the Z axis to that of its height.

FIG. 1 shows a schematic perspective depiction of a closure device in the closure position. This FIG. 1 more exactly shows the external face of said closure device 1, i.e. the face directed toward the outside of the motor vehicle.

Said closure device 1 has a support frame 5 comprising in particular two longitudinal crossmembers 5a, extending parallel to the Y axis of the trihedron, and at least two lateral uprights 5b, extending parallel to the Z axis of the trihedron and connecting said longitudinal crossmembers 5a. Advantageously, the support frame 5 is made from plastic material and the two longitudinal crossmembers 5a and the at least two lateral uprights 5b are obtained by injection molding. In order to improve the stiffness of said support frame 5, the latter may be molded as a single component.

The one or more flaps 3 are installed within said support frame 5. When there is a plurality of flaps 3, the latter form rows of flaps 3 that are mutually parallel and form a set of flaps 3. At one of the ends of the flap 3 or the set of flaps 3, there is placed a control element 13 allowing the one or more flaps 3 to rotate about a pivoting axis A, between an open position (not shown), in which the one or more flaps 3 are disposed such that a flow of air can pass through the closure device 1, in particular inside the support frame 5, and a closure position illustrated in FIG. 1, in which the one or more flaps 3 are arranged such that a flow of air cannot pass through the closure device 1.

As illustrated in FIG. 1, it is possible to have a device 1 for closing a motor vehicle front face air inlet that has a plurality of sets of flaps 3 extending for example over the entire width of the support frame 5. The sets of flaps 3 may be separated by the control element 13 in order to ensure their synchronous rotation.

As shown in FIG. 2, the control element 13 has in particular a rod 7. The one or more flaps 3 have a control arm 39 that is perpendicular to their pivoting axis A and bears a connection stud 303 (visible in FIG. 3) along a connection axis B. The connection stud 303 allows the flap 3 and the rod 7 to be connected. The pivoting axis A and the connection axes B are not coincident and are both parallel to the Y axis of the trihedron. Said control arm 39 is generally integral with said flaps 3.

The one or more flaps may be of the extruded or injected type.

The control element 13 also has an actuator 9. The actuator 9 may be electric, such as for example an electric motor, or pneumatic, such as for example a pneumatic cylinder. Said actuator 9 applies to the rod 7 a translational movement along the Z axis of the trihedron, by pivoting of a lever 11.

The flaps 3 may each pivot about a pivoting axis A defined by their connection with the support frame 5. The connection studs 303 between the flaps 3 and the control rod 7 are off-center relative to the pivoting axes A such that a translational movement of the control rod 7 parallel to the Z axis of the trihedron, under the action of the actuator 9, causes the flaps 3 to pivot about their respective pivoting axes A and therefore causes said flaps 3 to pass from one position to another.

Since all the flaps 3 are connected to the same rod 7, the passage from an open position to a closure position is synchronous for all said flaps 3. It is also possible that the set only has a single flap 3.

As shown in FIG. 3, a flap 3 may have a flap body 31 that is elongated along its pivoting axis A and has a length L. The flap body 31 may in particular have a transverse section of width 1. The transverse section of the flap body 31 may more particularly have a substantially oval profile. It is nevertheless entirely possible to imagine other shapes for the profile of the transverse section of the flap body 31, such as for example rectangular or with a hollow central portion from which fins emerge.

End pieces 30 are disposed at each end of the flap body 31. In the present case, reference is made to ends in the longitudinal direction of the flap body 31. The end pieces 30 have, on a first face directed toward the flap body 31, protrusions 300 that protrude parallel to the pivoting axis A in order to be embedded at the ends of the flap body 31. Said end pieces 30 also have, on a second face opposite the first face, a finger 301 extending along the pivoting axis A of the flap 3 and cooperating with a bearing borne by the support frame 5. The end pieces 30 may also have, at their interface with the ends of the flap body 31, a collar 302 extending perpendicular to the pivoting axis A. Said collars 302 in particular allow the support frame 5 and the control element 13 to be protected from water or dust that could reach the flap body 31.

At least one of the end pieces 30 also has, on its second face, the connection stud 303 extending along the connection axis B, so as to form the control arm 39 and allow the flap 3 to be connected with the rod 7.

The end pieces 30 are preferably made from plastic material by injection molding. Said end pieces 30 may have different shapes, as illustrated in FIG. 3, or identical shapes, this allowing savings to be made on production costs.

As is visible in FIG. 4, the lever 11 has:
an engagement part 15 arranged so as to engage in a corresponding recess 16 of a component 17, in this case an actuator with the same function as the actuator 9, with which the lever 11 is intended to cooperate,
a base 18 to which the engagement part 16 of generally cylindrical shape is connected,
a connection region 20 between the engagement part 16 and the base 18, this connection region 20 having a profile extending from the engagement part 16 toward the base 18, which profile has a progressive curve shape, this connection region 20 also comprising stops 21 that are adjacent to the profile with progressive curve shape.

The lever has a mounting member 22 arranged so as to cooperate with the rod 7. The member 22 extends on a side opposite the base 18.

The engagement part 16 is arranged so as to form, with the recess 16 of the associated component, a connection for setting the actuator 17 in rotation about an axis of rotation B in order to cause the lever 11 to turn.

The connection region 20 has a plurality of stops 21 that are evenly angularly distributed around the axis of rotation B. In other words, the stops are distributed over the connection region 20 with a regular interval between each stop, this better ensuring the distribution of the forces. It may also be said that the intervals between two stops are equal to one another, in particular angularly.

The profile 24 with progressive curve shape is present between two neighboring stops 21, as is visible in FIG. 5.

Each stop 21 has at its end a flat 25 arranged so as to come to bear on a collar 26 of the associated component 17.

The engagement part 16 has ribs 26 that are parallel to the axis of rotation B, and the stops 21 are each arranged in the extension of one of these ribs 26.

The profile with progressive curve shape is an arc of a circle.

The profile with progressive curve shape extends along the entire length of the stop.

The profile with progressive curve shape is more extensive than the collar of the component with which the lever 11 is intended to cooperate.

The engagement part 16 is connected to a sector 27 of the base 18 that is substantially circular.

As may be seen in FIG. 4, the base 18 is moved away by a non-zero distance from the collar of the component 17 with which the lever is intended to cooperate.

The lever 11 is made in a single piece from plastic material.

The lever 11 is arranged so as to be disposed between a rod 7 and an actuator 17 of a closure device for a motor vehicle front face air inlet.

25

1. A lever comprising:
an engagement part arranged so as to engage in a corresponding recess of a component with which the lever is intended to cooperate;
a base to which the engagement part is connected; and
a connection region between the engagement part and the base, the connection region comprising:
a profile extending from the engagement part toward the base, wherein the profile has a progressive curve shape, and
at least one stop that is adjacent to the profile with progressive curve shape.

2. The lever as claimed in claim 1, wherein the connection region has a plurality of stops, which are evenly angularly distributed around the axis of rotation A.

3. The lever as claimed in claim 1, wherein the stop has at its end a flat arranged so as to come to bear on a collar of the associated component.

4. The lever as claimed in claim 1, wherein the engagement part has ribs that are parallel to the axis of rotation, and the stops are each arranged in the extension of one of these ribs.

5. The lever as claimed in claim 1, wherein the progressive curve shape of the profile is an arc of a circle.

6. The lever as claimed in claim 1, wherein the engagement part is connected to a sector of the base that is substantially circular.

7. The lever as claimed in claim 1, wherein the base is moved away by a non-zero distance from the collar of the component with which the lever is intended to cooperate.

8. The lever as claimed in claim 1, wherein the lever is made in a single piece from plastic material.

9. The lever as claimed in claim 1, wherein the lever is arranged so as to be disposed between a rod and an actuator of a closure device for a motor vehicle front face air inlet and wherein the component with which the lever is intended to cooperate is the actuator.

10. A closure device for a motor vehicle front face air inlet, comprising:
a support frame in which is installed at least one set of flaps pivoting between a closure position and an open position;
a rod that moves in translation and is connected to the at least one set of flaps so as to cause said at least one set of flaps to pass from one position to another;
an actuator arranged so as to actuate the rod; and
a lever disposed between the actuator and the rod, the lever comprising:
an engagement part that engages in a corresponding recess of the actuator,
a base to which the engagement part is connected, and
a connection region between the engagement part and the base, the connection region comprising a profile with a progressive curve shape extending from the engagement part toward the base, and at least one stop that is adjacent to the profile.
